(19) United States
(12) Patent Application Publication
(10) Pub. No.: US 2025/0068887 A1
(43) Pub. Date: Feb. 27, 2025

(54) FOUNDATION MODELS FOR PERSONALIZED, INTERACTIVE, AND DYNAMIC MANUALS FOR TECHNICAL ASSISTANCE

(71) Applicant: International Business Machines Corporation, Armonk, NY (US)

(72) Inventors: Dan Gutfreund, Brighton, MA (US); David Joel Edelsohn, White Plains, NY (US); Dinesh C. Verma, New Castle, NY (US); Shahrokh Daijavad, Morgan Hill, CA (US)

(21) Appl. No.: 18/453,370

(22) Filed: Aug. 22, 2023

(51) Int. Cl. G06N 3/0455

(52) U.S. Cl. CPC G06N 3/0455

(57) ABSTRACT

Computer-implemented methods for providing personalized, interactive, and dynamic manuals for technical assistance are provided. Aspects include obtaining data representative of one or more actions of a user and instruction data, where the data and the instruction data are associated with performing a task. Aspects also include generating a latent space representation based on the data and the instruction data, the latent space representation including a first set of vectors corresponding to the one or more actions and a second set of vectors corresponding to the instruction data. Aspects also include managing the instruction data based on a result of comparing the first set of vectors and the second set of vectors.

### BACKGROUND

The present disclosure generally relates to manuals for technical assistance, and more specifically, to techniques supportive of providing personalized, interactive, and dynamic manuals for technical assistance.

Technical manuals are a source of knowledge and guidance to support technical personnel in assembling, operating, and fixing mechanical systems. Some manuals are static documents and are not updated over time. In some cases, a technical manual may lack instructions for addressing all potential failures and associated fixes, especially in complex systems. For example, some technical manuals may be insufficient for supporting less experienced technicians encountering complex or rare problems. Techniques which address problems associated with instances in which the information provided by a technical manual is limited are desired.

### SUMMARY

Embodiments of the present disclosure are directed to computer-implemented methods for providing personalized, interactive, and dynamic manuals for technical assistance. According to an aspect, a computer-implemented method includes obtaining data representative of one or more actions of a user and instruction data, where the data and the instruction data are associated with performing a task. The method also includes generating a latent space representation based on the data and the instruction data, the latent space representation including a first set of vectors corresponding to the one or more actions and a second set of vectors corresponding to the instruction data. The method also includes managing the instruction data based on a result of comparing the first set of vectors and the second set of vectors.

Embodiments also include a computing system having a memory having computer readable instructions and one or more processors for executing the computer readable instructions. The computer readable instructions control the one or more processors to perform operations that include obtaining data representative of one or more actions of a user and instruction data, where the data and the instruction data are associated with performing a task. The operations also include generating a latent space representation based on the data and the instruction data, the latent space representation including a first set of vectors corresponding to the one or more actions and a second set of vectors corresponding to the instruction data. The operations also include managing the instruction data based on a result of comparing the first set of vectors and the second set of vectors.

Embodiments also include a computer program product having a computer readable storage medium having program instructions embodied therewith. The program instructions are executable by a processor to cause the processor to perform operations that include obtaining data representative of one or more actions of a user and instruction data, where the data and the instruction data are associated with performing a task. The operations also include generating a latent space representation based on the data and the instruction data, the latent space representation including a first set of vectors corresponding to the one or more actions and a second set of vectors corresponding to the instruction data. The operations also include managing the instruction data based on a result of comparing the first set of vectors and the second set of vectors.

In addition to one or more of the features described herein, the data and the instruction data are provided to a machine learning model, and generating the latent space representation includes converting the data to the first set of vectors and converting the instruction data to the second set of vectors, by the machine learning model.

In addition to one or more of the features described herein, managing the instruction data comprises at least one of: updating second instruction data comprised in the instruction data; deleting third instruction data comprised in the instruction data; adding, to the instruction data, fourth instruction data associated with performing the task; and maintaining the instruction data.

Additional technical features and benefits are realized through the techniques of the present disclosure. Embodiments and aspects of the disclosure are described in detail herein and are considered a part of the claimed subject matter.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings.

FIG. 1 depicts a block diagram of an example computer system for use in conjunction with one or more embodiments of the present disclosure.

FIG. 1 depicts a block diagram of an example computer system for use in conjunction with one or more embodiments of the present disclosure.

FIG. 2 depicts a block diagram of an example computing system for use in conjunction with one or more embodiments of the present disclosure.

FIG. 3 illustrates an example flowchart of a method in accordance with one or more embodiments of the present disclosure.

FIG. 4 illustrates an example flowchart of a method in accordance with one or more embodiments of the present disclosure is shown.

FIG. 5A and FIG. 5B are diagrams illustrating example aspects in accordance with one or more embodiments of the present disclosure.

FIG. 6 is a diagram illustrating an example of a foundation model for use in accordance with one or more embodiments of the present disclosure.

FIG. 7 is a diagram illustrating an example of a latent space representation for use in accordance with one or more embodiments of the present disclosure.

FIG. 8 illustrates an example flowchart of a method in accordance with one or more embodiments of the present disclosure.

FIG. 9 illustrates an example flowchart of a method in accordance with one or more embodiments of the present disclosure.

FIG. 10 illustrates an example flowchart of a method in accordance with one or more embodiments of the present disclosure.

FIG. 11 illustrates an example flowchart of a method in accordance with one or more embodiments of the present disclosure.

### DETAILED DESCRIPTION

According to example aspects of the present disclosure, systems, methods, and computer program products are described which support providing dynamic manuals capable of evolving over time to address aspects needed by users. The systems, methods, and computer program products support techniques for dynamically updating instruction data included in the manuals with respect to a task, for instances in which instructions relied upon by the users for completing the task is not specified in the current manual documentation.

In one or more embodiments, systems, methods, and computer program products for obtaining data representative of one or more actions of a user and obtaining instruction data are provided, in which the data and the instruction data are associated with performing a task. In one or more embodiments, the systems, methods, and computer program products support techniques for generating a latent space representation based on the data and the instruction data. The latent space representation includes a first set of vectors corresponding to the one or more actions and a second set of vectors corresponding to the instruction data. In one or more embodiments, the systems, methods, and computer program products support techniques for managing the instruction data based on a result of comparing the first set of vectors and the second set of vectors. Managing the instruction data includes at least one of updating at least a portion of the instruction data, deleting at least the portion of the instruction data, adding, to the instruction data, second instruction data associated with performing the task, and maintaining (e.g., without updating) the instruction data.

In one or more embodiments, generating the latent space representation includes converting the data to the first set of vectors and converting the instruction data to the second set of vectors, by a machine learning network. The machine learning network includes at least one of a multimodal foundation model, a transformer, and a translation architecture capable of converting the data.

In some embodiments, the data representative of the one or more actions is of a first modality included in a first set of modalities (e.g., image data, text data, audio data, graphical data), and the instruction data is of a second modality included in a second set of modalities (e.g., image data, metaverse data, user inputs). The machine learning network is a multimodal machine learning network trained to generate the latent space representation based on candidate data associated with the first set of modalities and the second set of modalities.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

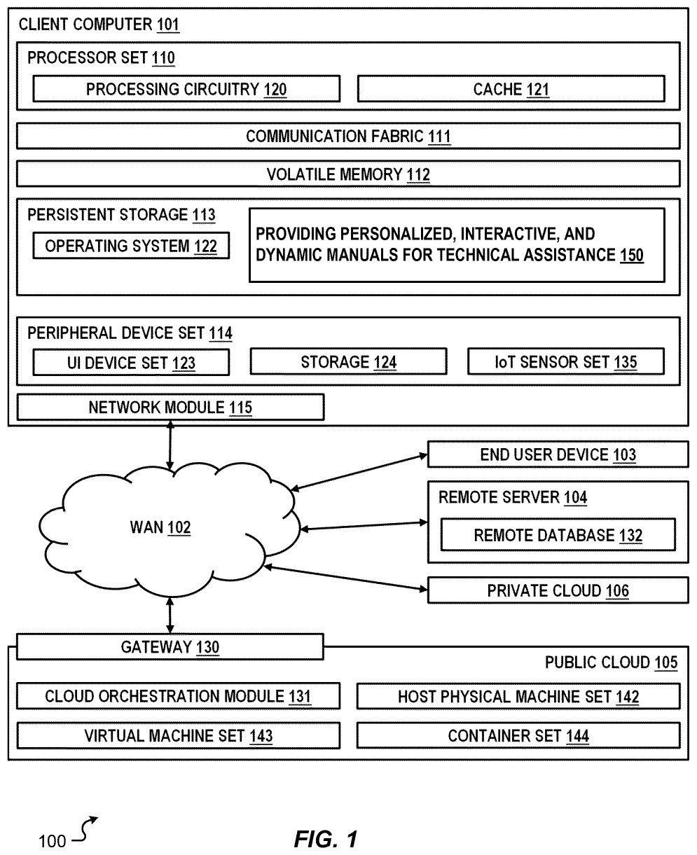

Referring to FIG. 1, Computing environment 100 contains an example of an environment for the execution of at least some of the computer code involved in performing the inventive methods, such as providing personalized, interactive, and dynamic manuals for technical assistance by block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 142. Public Cloud 105 includes gateway 130, Cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 142. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 142 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

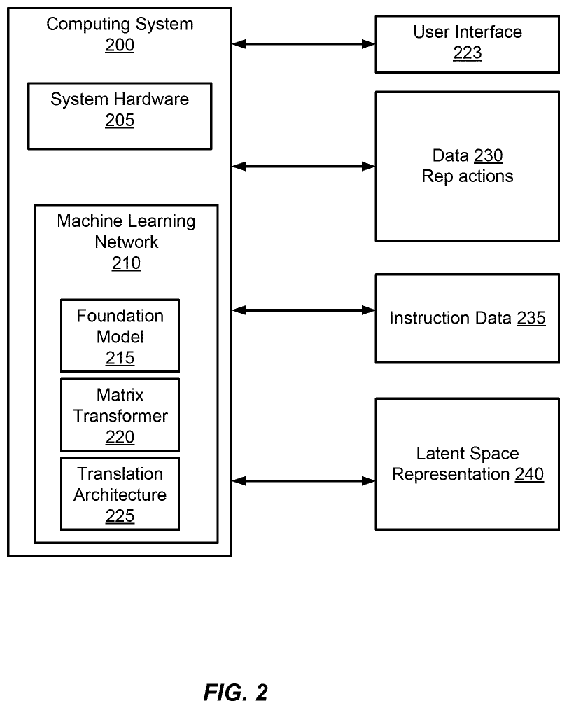

FIG. 2 depicts a block diagram of an example computing system 200 that supports providing personalized, interactive, and dynamic manuals for technical assistance in accordance with one or more embodiments of the present disclosure.

All or a portion of the system 200 shown in FIG. 2 can be implemented, for example, by all or a subset of the computing environment 100 of FIG. 1. In one or more embodiments, the computing system 200 is embodied in a computer 101 as the one shown in FIG. 1. In one or more embodiments, the computing system 200 is embodied in an end user device 103 as the one shown in FIG. 1.

The computing system 200 includes system hardware 205. The system hardware 205 includes the central processing units (CPUs), graphical processing units (GPUs), memory, and the like that are part of the computing system. The system hardware 205 executes computer code stored at a memory (e.g., volatile memory 112, persistent storage 113, storage 124, and the like described with reference to FIG. 1) of the computing system 200.

The computing system 200 includes a machine learning network 210. The computing system 200 may utilize data stored in a corresponding memory (e.g., memory of a computer 101, memory of a EUD 103, memory at a remote server 104, and the like) as a machine learning network 210. Machine learning network 210 may include a machine learning architecture. In some aspects, the machine learning network 210 may be or include one or more classifiers. In some other aspects, the machine learning network 210 may be or include any suitable machine learning network such as, for example, a deep learning network, a convolutional neural network, or the like. Some functions of the computing system 200 may be implemented using machine learning techniques.

The machine learning network 210 may include a machine learning model(s) (e.g., foundation model 215) which may be trained and/or updated based on data (e.g., training data) provided or accessed by the computing system 200. The machine learning model(s) may be built and updated by the computing system 200 based on the training data (also referred to herein as training data and feedback). In some aspects, the machine learning model(s) may be built and updated by the computing system 200 based on data generated by and/or operations performed by the 200.

The computing system 200 may be integrated with or be electrically coupled to a user interface 223. User interface 223 can be implemented by device set 123 of FIG. 1. The computing system 200 may provide (e.g., visually, audibly, and the like) instruction data 235 of a user manual via the user interface 223.

According to one or more embodiments of the present disclosure, the computing system 200 may obtain data 230 representative of one or more actions of a user (e.g., a technician, a field technician, and the like) and instruction data 235. The computing system 200 may obtain the data 230 and instruction data 235 from a data repository (e.g., remote database 132, storage 124, and the like of FIG. 1) or another device (e.g., another computing system 200). The terms “user,” “technician,” “field technician,” and “operator” may be used interchangeably herein.

In an example, the data 230 and the instruction data 235 are associated with performing a task. The task may be a single task including one or more operations. In some other aspects, the task may include multiple subtasks, each subtask including one or more operations. In some non-limiting examples, the task may be a task associated with an environment (e.g., a repair task associated with equipment included in an industrial environment, a maintenance task, and the like), but aspects of the present disclosure are not limited thereto.

The computing system 200 may be capable of generating a latent space representation 240 (also referred to herein as a latent space vector representation) based on the data 230 and the instruction data 235. The latent space representation 240 may be a vector representation of the data 230 and the instruction data 235. In one or more embodiments, the latent space representation 240 may include vectors corresponding to the one or more actions represented by the data 230 and vectors corresponding to the instruction data 235.

In one or more embodiments, the computing system 200 may provide the data 230 and the instruction data 235 to the machine learning network 210, and the machine learning network 210 may generate a latent space representation 240 from the data 230 and the instruction data.

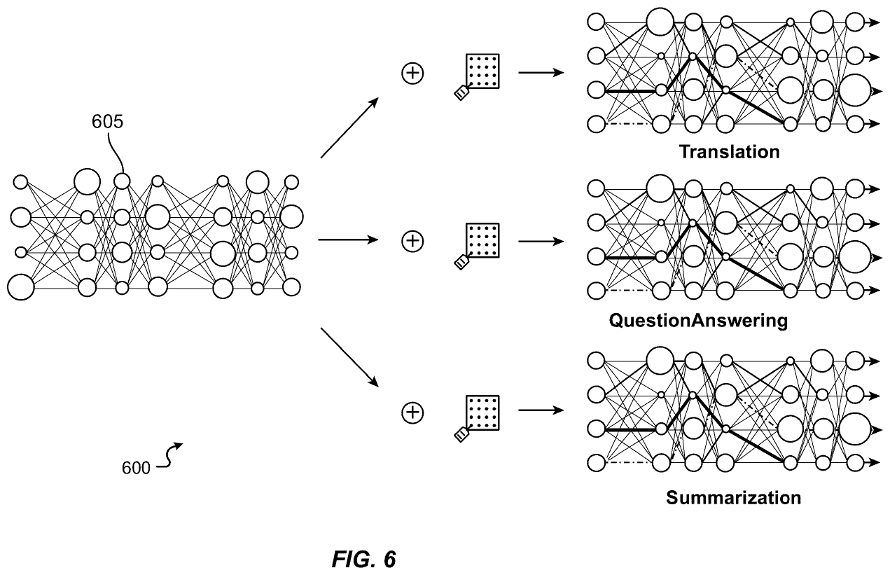

In one or more embodiments, the machine learning network 210 may include a foundation model 215 (or multiple foundation models 215) capable of generating the latent space representation 240. Example aspects of the foundation model 215 are later described herein with reference to FIG. 6.

In one or more embodiments, the machine learning network 210 may include a transformer 220 (or multiple transformers 220) capable of generating the latent space representation 240. The transformer 220 is a deep learning architecture including an encoder structure for generating output data (e.g., latent space representation 240) from input data (e.g., data 230, instruction data 235). In some examples, the transformer 200 may include an encoder-decoder structure.

In one or more embodiments, the machine learning network 210 may include a translation architecture 225 capable of generating the latent space representation 240. The translation architecture 225 may be a neural network or model capable of performing machine translation tasks (e.g., automatically converting text or speech from one language into another). A non-limiting example of the translation architecture 225 is sequence-to-sequence (Seq2Seq) model with an encoder-decoder architecture.

It is to be understood that the example aspects and features described herein with reference to the machine learning network 210 may be implemented by any of the foundation model 215, transformer 220, and translation architecture 225, or any suitable machine learning model included in the machine learning network 210 for performing the techniques described herein.

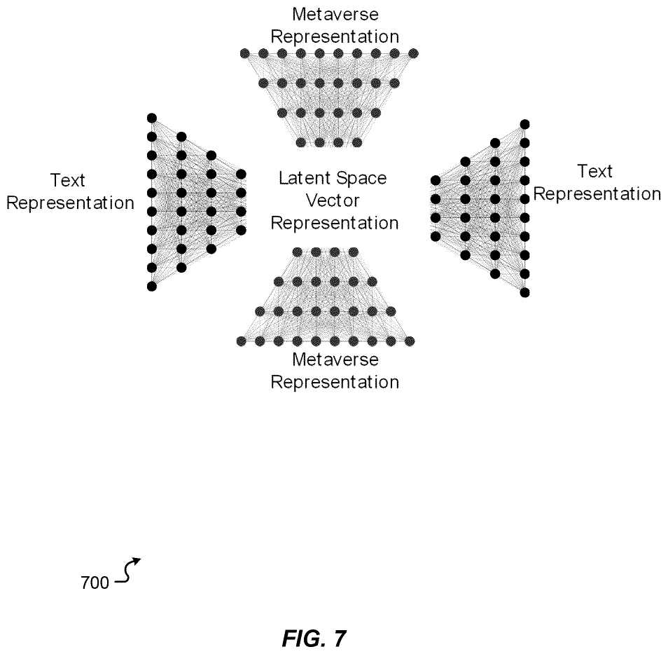

According to one or more embodiments of the present disclosure, the data 230 is of a first modality, and the instruction data 235 is of a second modality different from the first modality. Non-limiting examples of the modalities are described herein. The machine learning network 210 may be capable of generating the latent space representation 240 from the inputs (e.g., data 230 and instruction data 235) of different respective modalities. The latent space representation 240 may be a common latent space representation of the data 230 and the instruction data 235. For example, the latent space representation 240 may be a vector with multiple dimensions. Example aspects of the latent space representation 240 are later described with reference to FIG. 7.

Non-limiting examples of the modalities of the data 230 include image data, metaverse data, user inputs, and the like. In one or more embodiments, the data 230 includes image data of the user performing an action (or actions) associated with a task in a physical environment. The image data may include static images, video images, thermal images, and the like as captured by one or more sensor devices (e.g., camera devices, thermal sensors, depth sensors, motion sensors, and the like) associated with the computing system 200. For example, the sensor devices may be integrated with the computing system 200 or separate from (e.g., electronically or wirelessly coupled to) the computing system 200. Via the data 230, the computing system 200 may monitor the actions of the user in a physical environment (e.g., a field technician repairing a device in the field) or in a metaverse representation.

In one or more embodiments, the data 230 includes metaverse data of the user performing an action (or actions) associated with the task in a metaverse environment (e.g., a virtual reality (VR) environment, augmented reality (AR) environment, mixed reality (MR) environment, and the like).

In one or more embodiments, the data 230 includes a user input (or inputs) by at user interface 223 in association with performing an action (or actions) associated with the task. For example, the user input may include a keystroke, button press, mouse input, manipulation of equipment in association with performing a task, and the like.

In some aspects, the computing system 200 may receive the data 230 (e.g., image data, metaverse data, user input, and the like) described herein from a sensor device. Additionally, or alternatively, the computing system 200 may access the data 230 from a data repository (e.g., a database) to which the sensor device has transferred the data 230.

The instruction data 235 includes operations or user actions for performing a task. For example, the instruction data 235 may include operations or user actions included in a user manual or technical manual associated with tasks for maintaining, installing, or repairing equipment. Non-limiting examples of the instruction data 235 in accordance with one or more embodiments of the present disclosure include image data, text data, audio data, and graphical data.

The computing system 200 may provide the instruction data 235 in any suitable format for instructing a user to perform an operation or user action in association with completing a task. In one or more embodiments, the instruction data 235 includes image data (e.g., instructional images, video images, and the like), text data (e.g., text instructions), audio data (e.g., audio instructions), or graphical data (e.g., a flowchart, an instructional diagram, and the like) for instructing the user in association with performing a task. In one or more embodiments, the computing system 200 may provide the instruction data 235 via an application (e.g., a mobile application, a desktop application) executed at the computing system 200.

According to one or more embodiments of the present disclosure, the computing system 200 may manage the instruction data 235 based on an analysis of the latent space representation 240 of the data 230 (representative of a user action(s)) and the instruction data 235. For example, the computing system 200 may manage the instruction data 235 based on an analysis of the vector data representative of the data 230 (user action(s) included in the data 230) and the instruction data 235.

In accordance with example aspects of the present disclosure, the computing system 200 supports autonomous identification of discrepancies between a technical manual (e.g., instruction data 235) and user actions (e.g., data 230). The computing system 200 supports autonomous and/or semi-autonomous management (e.g., updating, maintaining) of the technical manual based on an analysis of the discrepancies. Example aspects of the management of the instruction data 235 are described herein with reference to the following figures.

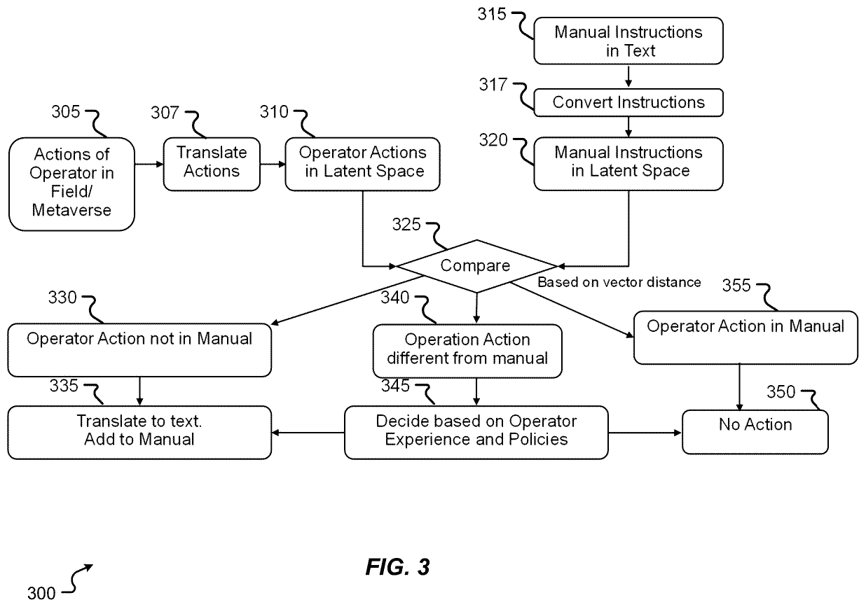

FIG. 3 illustrates an example flowchart of a method 300 that supports providing personalized, interactive, and dynamic manuals for technical assistance in accordance with one or more embodiments of the present disclosure.

At 307, the method 300 includes translating actions 305 (“Actions of Operator in Field/Metaverse”) of an operator in association with performing a task to a vector representation 310 (“Operator Actions in Latent Space”) included in a latent space representation. The latent space representation includes the example aspects of latent space representation 240 of FIG. 2. The actions 305 are examples of the actions (e.g., in the field, in the metaverse, and the like) described with reference to data 230 of FIG. 2. The terms “translating actions” and “converting actions” may be used interchangeably herein.

At 317, the method 300 includes converting instructions 315 (“Manual Instructions in Text”) associated with performing the task to a vector representation 320 (“Manual Instructions in Latent Space”) in the latent space representation. The instructions 315 are examples of the instruction data 235 of FIG. 2. For example, the instructions 315 may be included in a technical manual.

At 325, the method 300 includes comparing the vector representation 310 to the vector representation 320. For example, the method 300 may include using vector distance metrics to quantify the similarity or dissimilarity between the vector representation 310 and the vector representation 320. In an example, the method 300 includes calculating a vector distance between vectors of the vector representation 310 and the vector representation 320.

According to one or more embodiments of the present disclosure, based on a result of the comparison at 325, the method 300 includes determining whether an action included in the actions 305 is not included in the instructions 315, is different from the instructions 315, or is included in the instructions 315. Based on the comparison, the method 300 includes updating the instructions 315 or maintaining (e.g., refraining from updating) the instructions 315.

In an example, at 330 (“Operator Action not in Manual”), the method 300 determines from the vector distance that the action included in the actions 305 is not included in the instructions 315. At 335 (“Translate to Text. Add to Manual”), the method 300 includes translating one or more vectors included in the vector representation 310 and/or one or more vectors included in the vector representation 320 to additional instructions (e.g., text) for inclusion in the instructions 315 (e.g., additional instructions to be added to the technical manual). In one or more embodiments, the method 300 includes adding the additional instructions to the instructions 315. In one or more embodiments, the method 300 includes replacing one or more existing instructions included in the instructions 315 with the additional instructions. Accordingly, for example, the method 300 supports updating the instructions 315 to add missing steps for performing a task (e.g., for a use case not previously encountered) and/or replace steps associated with performing a task (e.g., replacing redundant steps, replacing inefficient steps, replacing steps determined by the computing system 200 to be confusing for users, and the like).

In another example, at 340 (“Operator Action different from Manual”), the method determines from the vector distance that an action ‘X’ included in the actions 305 performed by the operator is different from an action ‘Y’ included in the instructions 315. At 345 (“Decide based on Operator Experience and Policies”), the method 300 includes determining, based on operator experience and policies, whether to proceed to 335 (e.g., translate the action ‘X’ to additional instructions, update the manual with the additional instructions) or 350 (“No Action”) (e.g., take no action, refrain from updating the instructions 315).

For example, at 345, the computing system 200 may generate and output one or more inquiries to the operator with respect to the action ‘X.’ In an example, the computing system 200 may implement a chatbot program for determining, from the operator, reasons for which the operator performed action ‘X’ instead of action ‘Y.’ Based on the responses from the operator, the computing system 200 may proceed to 335 or to 350. In some aspects, at 345, the computing system 200 may determine an experience level of the operator. In an example, the computing system 200 may decide whether to proceed to 335 or 350, further based on whether the operator is an experienced user (e.g., based on an analysis of seniority level, position, performance metrics, and the like of the operator) or an inexperienced user.

In one or more embodiments, the operations described with reference to 345 may be implemented using the machine learning network 210 described herein, a rules-based engine executed by the computing system 200, and the like.

In another example, at 355 (“Operator Action in Manual”), the method 300 determines from the vector distance that the action included in the actions 305 is included in the instructions 315. In an example, the computing system 200 proceeds to 350.

The features described herein with reference to method 300 may be implemented by the computing system 200 of FIG. 2. In one or more embodiments, the features may be implemented by the machine learning network 210 of FIG. 2.

Non-limiting examples of criteria based on which the computing system 200 may update or maintain the instructions 315 are described herein. In an example, the computing system 200 updates the instructions 315 in response to determining that an operator who has performed actions different from instructions included in the manual is an experienced operator. In another example, the computing system 200 updates the instructions 315 in response to determining that an operator who has performed actions not included in the manual is an experienced operator.

In an example, the computing system 200 updates the instructions 315 in response to determining an operator is inexperienced and has taken actions different from instructions included in the manual (e.g., portions of the manual may lack clarity). In another example, the computing system 200 updates the instructions 315 in response to determining the operator is inexperienced, and the amount of time taken by the operator for performing an action exceeds a threshold temporal duration (e.g., portions of the manual may be missing key steps for completing a task).

In an example, the computing system 200 updates the instructions 315 in response to determining the operator is skipping steps included in the manual (e.g., the manual may have redundant steps). In another example, the computing system 200 updates the instructions 315 in response to determining the number of operators deviating from the instructions in the manual exceeds a threshold number (e.g., majority voting to decide if the manual is missing sections, includes redundant or unclear steps, and the like).

In accordance with one or more embodiments of the present disclosure, the systems, methods, and computer program products described herein can support multiple modes of operation. The techniques described herein may include updating manuals based on pre-collected videos/metaverse sessions. In some aspects, the techniques described herein include providing interactive updates as operators are training themselves in real-time in a metaverse environment. In some other aspects, the techniques described herein may include video observing end-users and performing (e.g., automatically or semi-automatically) updating a manual in real-time.

In accordance with one or more embodiments of the present disclosure, the systems, methods, and computer program products described herein can support techniques for reducing complexity associated with implementing comparisons of actions described in a manual and actions performed by an operator. For example, the techniques described herein may include mapping the actions described in the manual and the actions performed by the operator (e.g., metaverse actions, actions in the field) to an ‘if condition then action’ format. In some examples, conditions included in the ‘if condition then action’ format cover the status signals/error codes displayed on a device (e.g., red light, status code E7, and the like) associated with a maintenance task. In an example, an ‘action’ described herein includes steps taken by operator (e.g., remove cover, remove screws, and the like).

Accordingly, for example, in accordance with one or more embodiments of the present disclosure, systems, methods, and computer program products are disclosed which support techniques for dynamically updating technical manuals. In one or more embodiments, the techniques may include monitoring the actions of field technicians repairing devices in the field or in a metaverse representation. In one or more embodiments, the techniques may include converting manual contents and technical actions into a latent space representation using a foundation model. In one or more embodiments, the techniques may include comparing the technician action and manual instructions in the latent space, deciding whether the differences in actions require updating the manual, and translating the differences from the latent space to manual content using a foundation model. As described herein, the techniques described herein include determining, based on vector distance, if and how to update the manual content. The techniques described herein include translating the vectors (e.g., included in the vector representation 310 and/or vector representation 320) to natural language that can be added to the manual content.

The techniques described herein at least with reference to FIG. 3 may be referred to as machine learning inference. Machine learning inference is the process of running data points into a machine learning model to calculate an output. During inference, for example, the manual content is potentially updated (e.g., maintained, updated) as described herein, and the model weights based on which the machine learning model calculates the output are fixed.

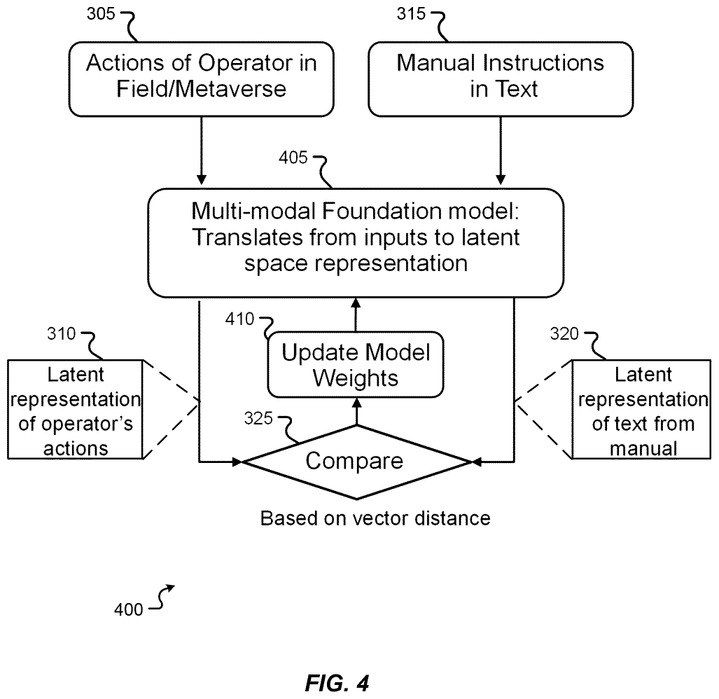

FIG. 4 illustrates an example flowchart of a method 400 of training a machine learning model 405 in accordance with one or more embodiments of the present disclosure is shown. The machine learning model 405 is an example of foundation model described with reference to FIG. 2 and FIG. 6.

Descriptions of features of actions 305, vector representation 310, instructions 315, vector representation 320, and block 325 illustrated in FIG. 4 are previously provided with reference to FIG. 3, and repeated descriptions are omitted for brevity.

At 410, the method 400 includes updating model weights of the machine learning model 405. For example, the method 400 includes updating one or more weighting parameters (also referred to herein as weighting factors) used by the machine learning model 405 in association with generating latent space representations, based on the comparison result at 325. During training of the machine learning model 405, model weights are updated, without updating manual content.

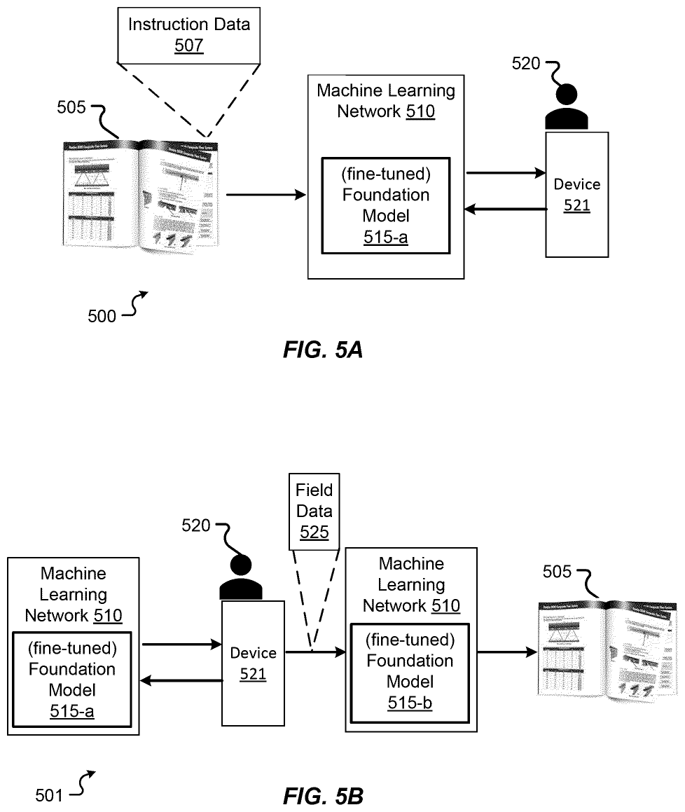

FIG. 5A and FIG. 5B include diagrams 500 and 501 illustrating example aspects supported by the systems (e.g., computing environment 100, the computing system 200) described herein in accordance with one or more embodiments of the present disclosure.

Referring to FIG. 5A, the techniques described herein support customizing a user manual 505 (and instruction data 507 included in the user manual 505)) for a user 520 at a user device 521. In one or more embodiments, the user device 521 is embodied in a computer 101 or in an end user device 103 as shown in FIG. 1.

For example, the techniques described herein include managing the instruction data 507 such that the instruction data 507 is customized for the user 520. For example, the techniques described herein support customizing, by a machine learning network 510 (e.g., a fine-tuned foundation model 515-a of the machine learning network 510), the instruction data 507 based on experience level. Non-limiting examples of users according to experience level include an inexperienced user, an experienced user, and the like. Customizing the instruction data 507 may include updating one or more portions of the instruction data 507, deleting one or more portions of the instruction data 507, adding to the instruction data 507, or maintaining (e.g., refraining from modifying) the instruction data 507.

Referring to FIG. 5B, the techniques described herein support further customizing the user manual 505 (and instruction data 507 included in the user manual 505)) and foundation model 515-b based on field data 525. The field data 525 may include operator actions as described herein. In one or more embodiments, the techniques described herein support dynamically updating the user manual 505 (and instruction data 507) in response to user decisions. For example, based on an analysis of a user action with respect to performing a task included in the instruction data 507 (e.g., did the user perform the step(s) provided in the instruction data 507, perform a step(s) different from the steps provided in the instruction data 507, take an extended period of time to perform the step(s), and the like), the techniques described herein may maintain or dynamically update the instruction data 507 with respect to performing the task.

Particular aspects of the subject matter described herein may be implemented to realize technical manuals which are personalized, interactive, and dynamically updated based on data (e.g., operator actions) from the field, which may provide a reduction in operator error, operator confusion, and overall duration for completing a task. The techniques described herein support dynamically tuning a technical manual based on the operator actions and operator experience level. The techniques described herein of personalizing and dynamically tuning a technical manual per user (or per experience level of the user) may support increased operator efficiency and reduced operator error with respect to performing a task.

Furthermore, the examples described herein of using a machine learning network 510 provide full automation of the process of identifying discrepancies between the instruction data 507 and operator actions in association with performing a task, and further, full and/or semi-automation of updating the user manual 505 based on the discrepancies. The techniques described herein of dynamically updating the user manual 505 provide advantages of knowledge base of instructions for addressing potential failures and their fixes (e.g., especially in complex systems), in which the instructions have a higher level of correctness, accuracy, and clarity and a reduced amount of redundant instructions compared to other techniques for providing technical manuals and instructions.

FIG. 6 is a diagram 600 illustrating an example of a foundation model 605 in accordance with one or more embodiments of the present disclosure.

A foundation model is a large AI model trained on a vast quantity of unlabeled data which can be adapted to a wide range of downstream tasks. Example key properties of a foundation model include self-supervision, use of transfer learning, transformer models (matched to hardware), large datasets, a cross domain structure, and an ability to generate constraints.

In one or more embodiments, the foundation model 605 supports features for machine translation tasks, question answering, and summarization in association with providing personalized, interactive, and dynamic manuals for technical assistance. For example, the foundation model 605 is capable of processing an input in one language and can generating corresponding translations in another language, understanding the context of a question and generating an answer, and generating text summarizations of text data.

FIG. 7 is a diagram illustrating an example of a latent space representation 700 in accordance with one or more embodiments of the present disclosure.

In an example, a foundation model (e.g., foundation model 215, foundation model 605) described herein is capable of converting any input into a latent space representation 700.

Referring to FIGS. 2 and 7, in an example in which the data 230 representative of one or more actions of a user is a metaverse representation and the instruction data 235 is a text representation, the foundation model is capable of translating the metaverse actions and text representation to the latent space representation 700 (e.g., a common latent space representation (a vector with many dimensions)). The foundation models described herein support generating a latent space representation 700 from inputs of any suitable modality (e.g., video images, static images, metaverse representation, text representation, and the like) described herein.

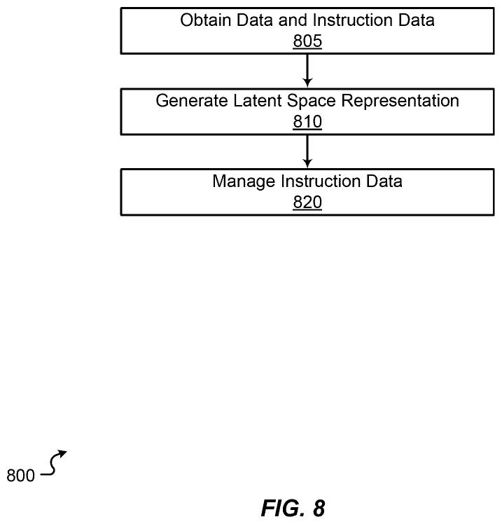

FIG. 8 illustrates an example flowchart of a method 800 that supports providing personalized, interactive, and dynamic manuals for technical assistance in accordance with one or more embodiments of the present disclosure.

At 805, the method 800 includes obtaining data representative of one or more actions of a user and instruction data, wherein the data and the instruction data are associated with performing a task. At 810, the method 800 includes generating a latent space representation based on the data and the instruction data, the latent space representation including a first set of vectors corresponding to the one or more actions and a second set of vectors corresponding to the instruction data. At 820, the method 800 includes managing the instruction data based at least in part on a result of comparing the first set of vectors and the second set of vectors.

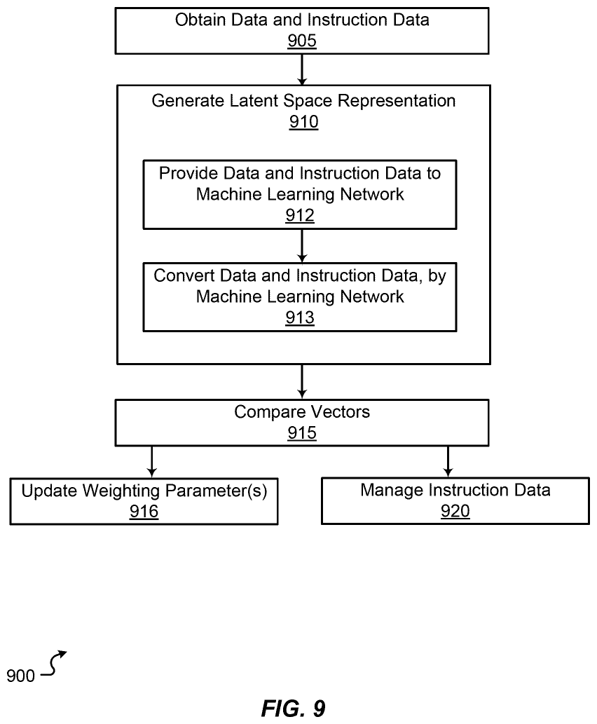

FIG. 9 illustrates an example flowchart of a method 900 for creating a machine learning model in accordance with one or more embodiments of the present disclosure.

At 905, the method 900 includes obtaining data representative of one or more actions of a user and instruction data, wherein the data and the instruction data are associated with performing a task.

In one or more embodiments, the data representative of the one or more actions includes at least one of: image data of the user performing the one or more actions in a physical environment; metaverse data of the user performing the one or more actions in a metaverse environment; and one or more inputs by the user at a user interface in association with performing the one or more actions, and the like, but is not limited thereto.

In one or more embodiments, the instruction data includes at least one of: image data associated with performing the task; text data associated with performing the task; audio data associated with performing the task; and graphical data associated with performing the task, and the like, but is not limited thereto.

At 910, the method 900 includes generating a latent space representation based on the data and the instruction data, the latent space representation including a first set of vectors corresponding to the one or more actions and a second set of vectors corresponding to the instruction data.

At 912, the method 900 includes providing the data and the instruction data to a machine learning network.

In one or more embodiments, at 913, generating the latent space representation includes converting the data to the first set of vectors and converting the instruction data to the second set of vectors, by the machine learning network.

In one or more embodiments, the machine learning network includes, but is not limited to, at least one of: a multimodal foundation model; a transformer; a translation architecture including an encoder and a decoder; and the like.

In one or more embodiments, the data is of a first modality included in a first set of modalities, the instruction data is of a second modality included in a second set of modalities, and the machine learning network is trained to generate the latent space representation based on candidate data associated with the first set of modalities and the second set of modalities.

At 915, the method 900 includes comparing the first set of vectors and the second set of vectors.

At 916, the method 900 includes updating at least one weighting parameter of the machine learning network associated with generating the latent space representation, based at least in part on the result of comparing the first set of vectors and the second set of vectors.

Alternatively, at 920, the method 900 includes managing the instruction data based at least in part on the result of comparing the first set of vectors and the second set of vectors.

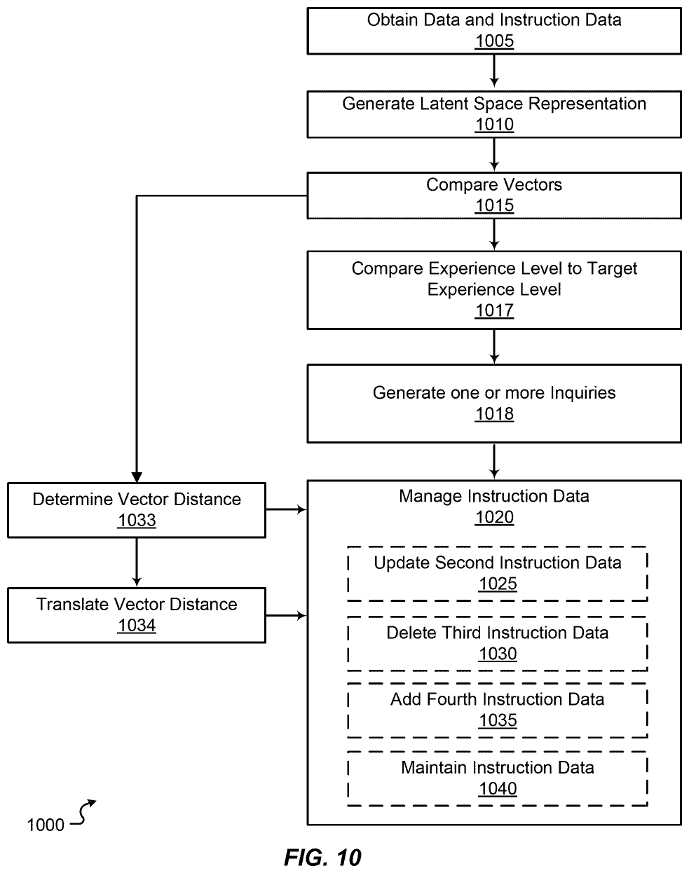

FIG. 10 illustrates an example flowchart of a method 1000 for creating a machine learning model in accordance with one or more embodiments of the present disclosure.

At 1005, the method 1000 includes obtaining data representative of one or more actions of a user and instruction data, wherein the data and the instruction data are associated with performing a task.

At 1010, the method 1000 includes generating a latent space representation based on the data and the instruction data, the latent space representation including a first set of vectors corresponding to the one or more actions and a second set of vectors corresponding to the instruction data.

At 1015, the method 1000 includes comparing the first set of vectors and the second set of vectors.

At 1017, the method 1000 includes comparing an experience level of the user to a target experience level.

At 1020, the method 1000 includes managing the instruction data.

In accordance with one or more embodiments of the present disclosure, managing the instruction data is based at least in part on a result of comparing the first set of vectors and the second set of vectors. In accordance with one or more embodiments of the present disclosure, managing the instruction data is based at least in part on a second result of comparing the experience level of the user to the target experience level.

In one or more embodiments, managing the instruction data includes at least one of: at 1025, updating second instruction data comprised in the instruction data; at 1030, deleting third instruction data comprised in the instruction data; at 1035, adding, to the instruction data, fourth instruction data associated with performing the task; and at 1040, maintaining the instruction data.

An example of managing the instruction data at 1020 in accordance with one or more embodiments of the present disclosure is described herein. At 1033, the method 1000 includes determining a vector distance between at least one first vector of the first set of vectors and at least one second vector of the second set of vectors. In one or more embodiments, managing the instruction data at 1020 is based at least in part on the vector distance.

An example of adding the second instruction data to the instruction data at 1035 in accordance with one or more embodiments of the present disclosure is described herein. At 1034, the method 1000 includes translating the vector distance. In one or more embodiments, at 1034, the method 1000 includes translating the at least one first vector, the at least one second vector, or both to second instruction data comprised in the instruction data associated with performing the task, where managing the instruction data at 1020 includes updating (at 1025) the second instruction data. In one or more embodiments, at 1034, the method 1000 includes translating the at least one first vector, the at least one second vector, or both to third instruction data associated with performing the task, where managing the instruction data includes deleting (at 1030, from the instruction data, the third instruction data. In one or more embodiments, at 1034, the method 1000 includes translating the at least one first vector, the at least one second vector, or both to fourth instruction data associated with performing the task, where managing the instruction data includes adding (at 1035), to the instruction data, the fourth instruction data.

An example of managing the instruction data at 1020 in accordance with one or more embodiments of the present disclosure is described herein. At 1018, the method 1000 includes generating one or more inquiries associated with the one or more actions based at least in part on the result of comparing the first set of vectors and the second set of vectors. In one or more embodiments, managing the instruction data at 1020 is based at least in part on processing one or more responses of the user in association with the one or more inquiries.

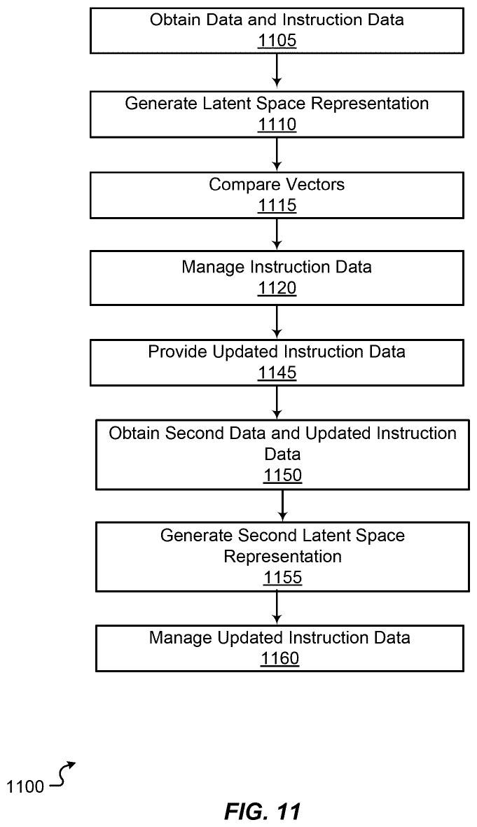

FIG. 11 illustrates an example flowchart of a method 1100 for creating a machine learning model in accordance with one or more embodiments of the present disclosure.

At 1105, the method 1100 includes obtaining data representative of one or more actions of a user and instruction data, wherein the data and the instruction data are associated with performing a task.

At 1110, the method 1100 includes generating a latent space representation based on the data and the instruction data, the latent space representation including a first set of vectors corresponding to the one or more actions and a second set of vectors corresponding to the instruction data.

At 1115, the method 1100 includes comparing the first set of vectors and the second set of vectors.

At 1120, the method 1100 includes managing the instruction data. In accordance with one or more embodiments of the present disclosure, managing the instruction data is based at least in part on a result of comparing the first set of vectors and the second set of vectors.

At 1145, the method 1100 includes providing updated instruction data in response to managing the instruction data.

At 1150, the method 1100 includes obtaining second data representative of one or more second actions of a user and the updated instruction data. In one or more embodiments, the second data and the updated instruction data are associated with performing the task.

At 1155, the method 1100 includes generating a second latent space representation based on the second data and the updated instruction data, the second latent space representation including a third set of vectors corresponding to the one or more second actions and a fourth set of vectors corresponding to the updated instruction data.

At 1160, the method 1100 includes managing the updated instruction data based at least in part on a result of comparing the third set of vectors and the fourth set of vectors.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure.

In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
obtaining data representative of one or more actions of a user and instruction data, wherein the data and the instruction data are associated with performing a task;
generating a latent space representation based on the data and the instruction data, the latent space representation comprising a first set of vectors corresponding to the one or more actions and a second set of vectors corresponding to the instruction data; and
managing the instruction data based at least in part on a result of comparing the first set of vectors and the second set of vectors.

2. The computer-implemented method of claim 1, further comprising:
providing the data and the instruction data to a machine learning network,
wherein generating the latent space representation comprises converting the data to the first set of vectors and converting the instruction data to the second set of vectors, by the machine learning network.

3. The computer-implemented method of claim 2, wherein the machine learning network comprises at least one of:
a multimodal foundation model;
a transformer; and
a translation architecture comprising an encoder and a decoder.

4. The computer-implemented method of claim 2, wherein:
the data is of a first modality comprised in a first set of modalities;
the instruction data is of a second modality comprised in a second set of modalities; and
the machine learning network is trained to generate the latent space representation based on candidate data associated with the first set of modalities and the second set of modalities.

5. The computer-implemented method of claim 1, further comprising:
updating at least one weighting parameter of a machine learning network associated with generating the latent space representation, based at least in part on the result of comparing the first set of vectors and the second set of vectors.

6. The computer-implemented method of claim 1, wherein managing the instruction data comprises at least one of:
updating second instruction data comprised in the instruction data;
deleting third instruction data comprised in the instruction data;
adding, to the instruction data, fourth instruction data associated with performing the task; and
maintaining the instruction data.

7. The computer-implemented method of claim 1, further comprising:
determining a vector distance between at least one first vector of the first set of vectors and at least one second vector of the second set of vectors,
wherein managing the instruction data is based at least in part on the vector distance.

8. The computer-implemented method of claim 7, further comprising at least one of:
translating the at least one first vector, the at least one second vector, or both to second instruction data comprised in the instruction data associated with performing the task, wherein managing the instruction data comprises updating the second instruction data;
translating the at least one first vector, the at least one second vector, or both to third instruction data associated with performing the task, wherein managing the instruction data comprises deleting, from the instruction data, the third instruction data; and
translating the at least one first vector, the at least one second vector, or both to fourth instruction data associated with performing the task, wherein managing the instruction data comprises adding, to the instruction data, the fourth instruction data.

9. The computer-implemented method of claim 1, wherein managing the instruction data is based at least in part on a second result of comparing an experience level of the user to a target experience level.

10. The computer-implemented method of claim 1, further comprising:
generating one or more inquiries associated with the one or more actions based at least in part on the result of comparing the first set of vectors and the second set of vectors,
wherein managing the instruction data is based at least in part on processing one or more responses of the user in association with the one or more inquiries.

11. The computer-implemented method of claim 1, wherein the data representative of the one or more actions comprises at least one of:
image data of the user performing the one or more actions in a physical environment;
metaverse data of the user performing the one or more actions in a metaverse environment; and
one or more inputs by the user at a user interface in association with performing the one or more actions.

12. The computer-implemented method of claim 1, wherein the instruction data comprises at least one of:
image data associated with performing the task;
text data associated with performing the task;
audio data associated with performing the task; and
graphical data associated with performing the task.

13. The computer-implemented method of claim 1, further comprising:
providing updated instruction data in response to managing the instruction data;
obtaining second data representative of one or more second actions of a user and the updated instruction data, wherein the second data and the updated instruction data are associated with performing the task;
generating a second latent space representation based on the second data and the updated instruction data, the second latent space representation comprising a third set of vectors corresponding to the one or more second actions and a fourth set of vectors corresponding to the updated instruction data; and
managing the updated instruction data based at least in part on a result of comparing the third set of vectors and the fourth set of vectors.

2. A computing system having a memory having computer readable instructions and one or more processors for executing the computer readable instructions, the computer readable instructions controlling the one or more processors to perform operations comprising:
obtaining data representative of one or more actions of a user and instruction data, wherein the data and the instruction data are associated with performing a task;
generating a latent space representation based on the data and the instruction data, the latent space representation comprising a first set of vectors corresponding to the one or more actions and a second set of vectors corresponding to the instruction data; and
managing the instruction data based at least in part on a result of comparing the first set of vectors and the second set of vectors.

15. The computing system of claim 14, wherein the computer readable instructions control the one or more processors to further perform operations comprising:
providing the data and the instruction data to a machine learning network,
wherein generating the latent space representation comprises converting the data to the first set of vectors and converting the instruction data to the second set of vectors, by the machine learning network.

16. The computing system of claim 15, wherein the machine learning network comprises at least one of:
a multimodal foundation model;
a transformer; and
a translation architecture comprising an encoder and a decoder.

17. The computing system of claim 15, wherein:
the data is of a first modality comprised in a first set of modalities;
the instruction data is of a second modality comprised in a second set of modalities; and
the machine learning network is trained to generate the latent space representation based on candidate data associated with the first set of modalities and the second set of modalities.

18. The computing system of claim 14, wherein the computer readable instructions control the one or more processors to perform further operations comprising:
updating at least one weighting parameter of a machine learning network associated with generating the latent space representation, based at least in part on the result of comparing the first set of vectors and the second set of vectors.

19. The computing system of claim 14, wherein managing the instruction data comprises at least one of:
updating second instruction data comprised in the instruction data;
deleting third instruction data comprised in the instruction data;
adding, to the instruction data, fourth instruction data associated with performing the task; and
maintaining the instruction data.

3. A computer program product comprising a computer readable storage medium having program instructions embodied therewith, the program instructions executable by a processor to cause the processor to perform operations comprising:
obtaining data representative of one or more actions of a user and instruction data, wherein the data and the instruction data are associated with performing a task;
generating a latent space representation based on the data and the instruction data, the latent space representation comprising a first set of vectors corresponding to the one or more actions and a second set of vectors corresponding to the instruction data; and
managing the instruction data based at least in part on a result of comparing the first set of vectors and the second set of vectors.
